(19) United States
(12) Patent Application Publication
(10) Pub. No.: US 2026/0199853 A1
(43) Pub. Date: Jul. 16, 2026

(54) AUTOMATED FERMENTATION MAINTENANCE AND DISPENSING SYSTEM

(71) Applicant: Bailey Rodgers, Festus, MO (US)

(72) Inventor: Bailey Rodgers, Festus, MO (US)

(21) Appl. No.: 19/562,759

(22) Filed: Mar. 11, 2026

Related U.S. Application Data
(60) Provisional application No. 63/846,500, filed on Jul. 18, 2025.
(60) Provisional application No. 63/847,469, filed on Jul. 20, 2025.

(51) Int. Cl. B01F 35/21; A21C 13/00; B01F 27/808; B01F 35/22; B01F 35/221; B01F 35/222; B01F 35/32; B01F 35/45; B01F 35/71; B01F 101/08

(52) U.S. Cl. CPC B01F 35/2117; A21C 13/00; B01F 27/808; B01F 35/21112; B01F 35/2202; B01F 35/2206; B01F 35/2211; B01F 35/222; B01F 35/3204; B01F 35/3213; B01F 35/45; B01F 35/71775; B01F 2101/08

(57) ABSTRACT

A fermentation maintenance machine is disclosed for dispensing measured quantities of liquid and dry particulate ingredients into a fermentation vessel. The machine includes a liquid container, a particulate container, and a housing body supporting a liquid dispensing assembly and a particulate dispensing assembly. The fermentation vessel is supported on a scale that provides weight feedback to a processor. The processor is configured to control dispensing based on target quantities and weight feedback. In certain embodiments, a flow meter associated with the liquid dispensing assembly and a rotation sensor associated with the particulate dispensing assembly provide additional dispensing feedback. The processor may reduce dispensing rates when a dispensed quantity approaches a predefined proximity band of a selected target quantity to improve precision. Optional features include lid actuation, vessel agitation, scheduled or autonomous dispensing modes, and environmental sensing for adaptive control.

### CROSS-REFERENCE TO RELATED APPLICATIONS

This application claims the benefit of U.S. Provisional Patent Application No. 63/846,500, filed on Jul. 18, 2025 and U.S. Provisional Patent Application No. 63/847,469, filed on Jul. 20, 2025, the entire contents of which are hereby incorporated by reference in their entirety.

### FIELD OF USE

The present disclosure relates generally to automated dispensing and control systems and, more particularly, to a machine and method for maintaining a fermentation vessel through controlled dispensing of liquid and dry particulate ingredients.

### BACKGROUND

Fermentation processes are commonly used in the preparation of food products such as sourdough bread, in which a starter culture is maintained through periodic addition of flour (e.g., wheat-based particulate material) and water. Maintaining a fermentation vessel often requires regular measurement and dispensing of precise quantities of liquid and dry ingredients to sustain microbial activity and achieve consistent fermentation performance. Conventional methods typically rely on manual measurement and timing, which may result in variability, inefficiency, or inconsistent outcomes. Accordingly, there exists a need for improved systems and methods for controlled and repeatable maintenance of a fermentation vessel.

### SUMMARY

In one aspect, a fermentation maintenance machine is provided for automatically dispensing measured quantities of liquid and dry particulate ingredients into a fermentation vessel. The machine includes a liquid container, which in certain embodiments may contain water, and a particulate container, which in certain embodiments may contain wheat flour or other dry fermentation-supporting material. A processor is communicatively coupled to dispensing assemblies and a scale supporting the fermentation vessel to control dispensing based on weight feedback.

In exemplary use, the fermentation vessel may contain a sourdough starter culture that is periodically maintained through the addition of water and wheat flour. The processor may receive a target quantity input and selectively actuate a liquid dispensing assembly and/or a particulate dispensing assembly to deliver measured amounts of water and wheat flour into the fermentation vessel. Dispensing may be terminated when feedback from the scale indicates that the target quantity has been reached.

In certain embodiments, dispensing precision may be enhanced through use of a flow meter associated with the liquid dispensing assembly and a rotation sensor associated with the particulate dispensing assembly. The processor may reduce dispensing rates as a measured or estimated dispensed quantity approaches a predefined proximity band of a selected target quantity, thereby allowing final dispensing to be regulated primarily by weight feedback from the scale.

In further embodiments, the machine may operate in scheduled or autonomous modes to maintain a sourdough starter over extended periods. Optional features may include automatic lid actuation, activation of an agitator within the fermentation vessel, environmental sensing, and adaptive feeding intervals based on stored parameters or sensed conditions.

While sourdough starter maintenance using water and wheat flour is described as an illustrative example, the system may be used with other liquids and dry particulate ingredients in a variety of fermentation processes.

### BRIEF DESCRIPTION OF DRAWINGS

FIG. 1 illustrates a front elevation view of the fermentation maintenance machine.

FIG. 2 illustrates a rear elevation view of the fermentation maintenance machine with a portion of the housing removed to expose internal dispensing assemblies.

FIG. 3 illustrates a perspective view of the particulate dispensing assembly.

FIG. 4 illustrates a side elevation view of the particulate dispensing assembly showing the rotatable displacement member and associated components.

FIG. 5 illustrates a perspective view of the liquid dispensing assembly.

FIG. 6 illustrates a partially disassembled perspective view of the liquid dispensing assembly showing the pump, flow meter, and fluid pathway components.

FIG. 7 illustrates an automated iris-style lid embodiment.

FIG. 8 illustrates a base-driven magnetic agitation embodiment.

FIG. 9 illustrates a base-driven mechanical agitation embodiment.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

The word “coupled” herein means a direct connection or an indirect connection.

The text describes one or more specific embodiments of a broader invention.

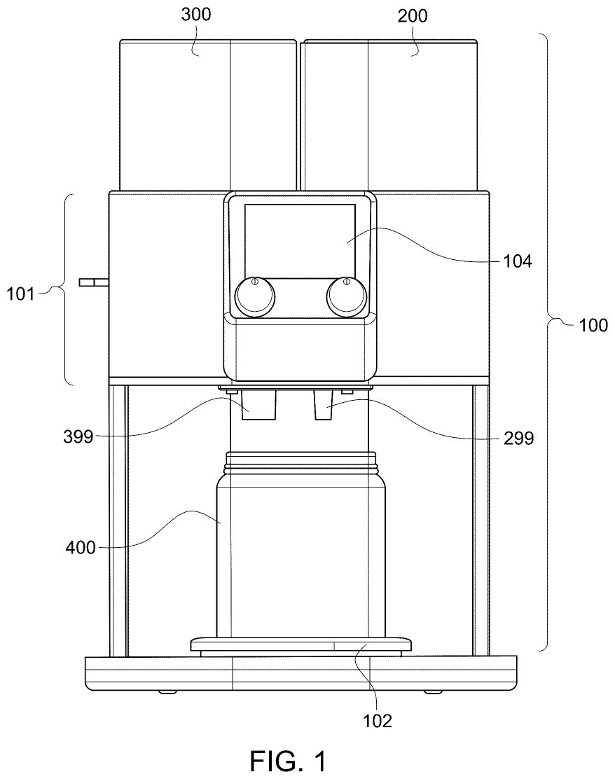

FIG. 1 illustrates a front elevation view of a fermentation maintenance machine 100. The fermentation maintenance machine 100 includes a housing body 101 that supports and encloses internal mechanical and electronic components. A liquid container 200 and a particulate container 300 are coupled to the housing body 101 and positioned to supply liquid and particulate material, respectively.

A user interface 104 is disposed on an exterior portion of the housing body 101. The user interface 104 may include a display and one or more input mechanisms including touch-sensitive controls, buttons, or rotary selectors. The user interface 104 is communicatively coupled to a processor 103 configured to control operation of the machine.

In certain embodiments, the processor 103 includes wireless communication capability and may communicate using short-range or long-range wireless communication protocols including radio frequency communication, local area network communication, near-field communication, cellular communication, or equivalent wireless communication technologies.

A liquid dispensing spout 299 and a particulate dispensing spout 399 extend from the housing body 101 and are positioned to direct dispensed materials into a fermentation vessel 400. The fermentation vessel 400 may include a lid 410 and a fermentation vessel agitator 420 disposed therein.

The fermentation vessel 400 is supported upon a scale 102. The scale 102 is communicatively coupled to the processor 103 and provides weight feedback corresponding to contents within the fermentation vessel 400.

The fermentation maintenance machine 100 further includes a power supply configured to provide electrical power to the processor 103, user interface 104, scale 102, motors, pumps, sensors, and associated electronic components. In certain embodiments, the power supply includes an alternating current input with an internal transformer and rectifier configured to convert alternating current to regulated direct current voltage. In other embodiments, the power supply may include one or more rechargeable batteries. The power supply may further include voltage regulation circuitry and protective components to ensure stable operation of the system.

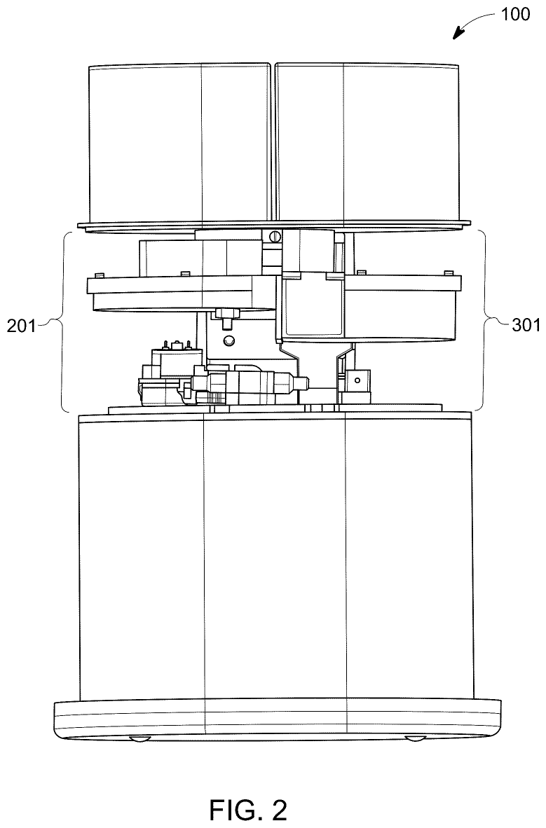

FIG. 2 illustrates a rear elevation view of the fermentation maintenance machine 100 with a portion of the housing body 101 removed to expose internal components, including the liquid dispensing assembly 201, particulate dispensing assembly 301.

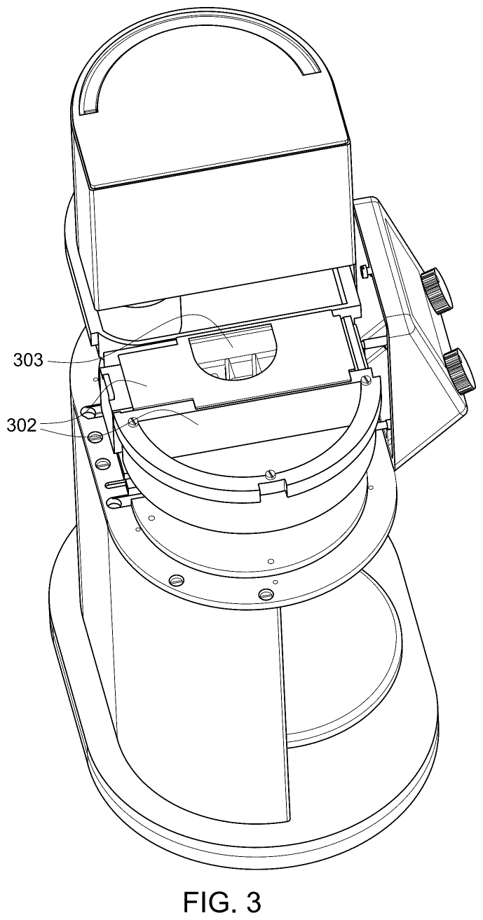

FIG. 3 illustrates an aerial perspective view of the particulate dispensing assembly 301. The particulate dispensing assembly 301 includes a particulate dispensing housing 302 having a particulate dispensing entry hole 303 positioned to receive particulate material from a lower opening of the particulate container 300. The particulate dispensing housing 302 defines an internal chamber within which particulate material may be laterally displaced. A particulate dispensing exit hole 306 is positioned downstream within the housing.

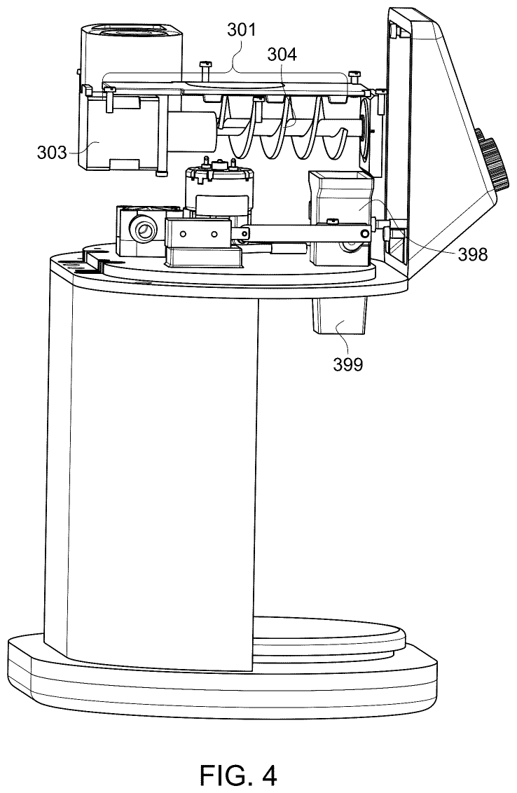

FIG. 4 illustrates a side elevation view of the fermentation maintenance machine 100 with portions of the housing body 101 and particulate dispensing housing 302 removed to reveal internal components. Disposed within the particulate dispensing housing 302 is a motor 305 operatively coupled to a rotatable displacement member 304. The motor 305 is communicatively coupled to the processor 103 and receives controlled power from the power supply.

As seen in FIG. 4, the rotatable displacement member 304 includes a shaft operatively coupled to the motor 305 and at least one material engagement structure extending outwardly from the shaft. The material engagement structure may include one or more paddles, blades, helical flighting, sweeping arms, or equivalent structures configured to displace particulate material upon rotational actuation. The rotatable displacement member 304 is configured to laterally redistribute particulate material within the particulate dispensing housing 302 toward the particulate dispensing exit hole.

A rotation sensor may be coupled to the motor 305 or the shaft of the rotatable displacement member 304 to detect rotational movement and provide feedback to the processor 103 regarding displacement activity.

Particulate material displaced through the particulate dispensing exit hole enters a duct 398. A shutter door assembly 350 is positioned along the duct 398 to selectively permit or block passage of particulate material from the duct 398 to the particulate dispensing spout 399. The shutter door assembly 350 includes a shutter door motor 351, a shutter door arm 352, and a shutter door flap 353. The shutter door motor 351 is communicatively coupled to the processor 103 and power supply. Upon activation, the shutter door motor 351 actuates the shutter door arm 352, which is operatively coupled to the shutter door flap 353. In certain embodiments, the shutter door arm extends through an opening in a wall of the duct 398 and mechanically engages the shutter door flap 353 to move the shutter door flap between a closed position and an open position. In certain embodiments, the shutter door flap 353 pivots about a hinge. In other embodiments, the shutter door flap 353 comprises one or more telescoping segments configured to slidably extend and retract between open and closed positions. When opened, particulate material flows through the duct 398 and exits through the particulate dispensing spout 399 into the fermentation vessel 400.

In certain embodiments, the shutter door motor 351 is communicatively coupled to the processor 103. The processor 103 is configured to generate a control signal to actuate the shutter door motor 351 to move the shutter door flap 353 to the open position prior to or concurrent with initiation of particulate dispensing. Upon termination of dispensing, the processor 103 generates a control signal to return the shutter door flap 353 to the closed position, thereby preventing unintended discharge of particulate material.

In some embodiments, the processor 103 may confirm the open or closed state of the shutter door flap 353 using a position sensor, limit switch, or time-based actuation control. The shutter door assembly 350 may remain in the closed position during periods of inactivity to reduce contamination, moisture exposure, or unintended particulate release.

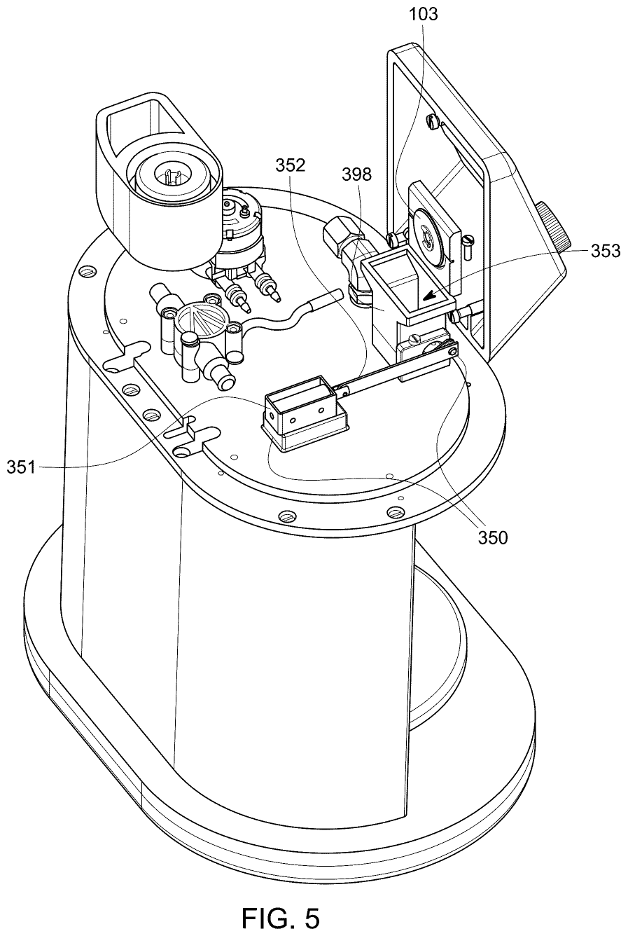

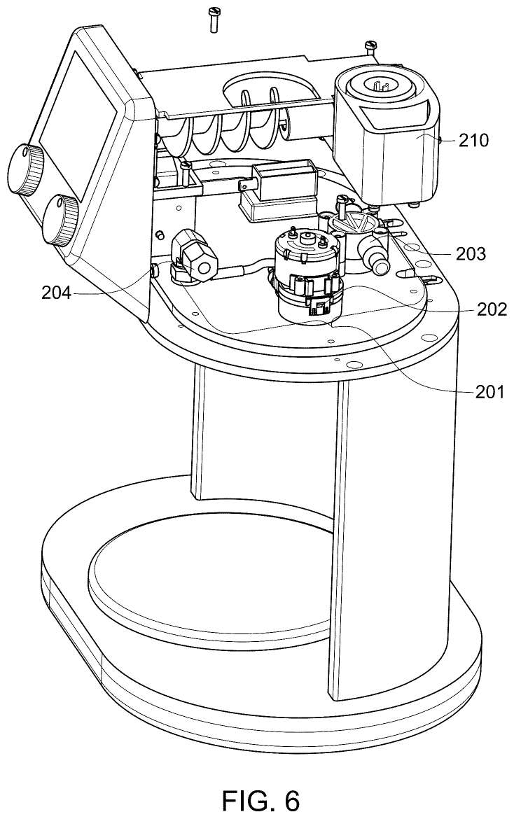

FIGS. 5 and 6 illustrate perspective views of the fermentation maintenance machine 100 with the housing body 101 and containers partially removed to expose the liquid dispensing assembly 201. The liquid container 200 includes an outlet port 210 positioned at a lower region to allow liquid to exit the container. The outlet port 210 places the liquid container 200 in fluid communication with a peristaltic pump 202. The peristaltic pump 202 is configured to draw liquid from the liquid container 200 and advance the liquid along a fluid pathway. In certain embodiments, the peristaltic pump 202 compresses flexible tubing to create positive displacement flow without direct contact between internal pump components and the liquid. In certain embodiments, the liquid container 200 and the particulate container 300 include a removable or attachable lid configured to permit refilling.

Disposed downstream of the peristaltic pump 202 is a flow meter 203 positioned along the fluid pathway. The flow meter 203 is configured to measure volumetric flow rate and/or cumulative volume of liquid passing therethrough and to provide corresponding feedback signals to the processor 103. A male stud elbow 204 is positioned downstream of the flow meter 203 and provides a directional change in the fluid pathway. The male stud elbow 204 may include threaded, barbed, compression, or equivalent fittings configured to couple adjacent fluid conduits and direct liquid toward the liquid dispensing spout 299. The liquid dispensing spout 299 directs liquid into the fermentation vessel 400. In certain embodiments, flexible tubing or equivalent fluid conduits place the outlet port 210, peristaltic pump 202, flow meter 203, male stud elbow 204, and liquid dispensing spout 299 in fluid communication.

The fermentation vessel 400 is supported upon a scale 102. The scale 102 includes one or more load cells configured to generate electrical signals corresponding to measured weight values. The scale 102 is communicatively coupled to the processor 103 and provides weight feedback during operation. As liquid and/or particulate material is dispensed into the fermentation vessel 400, the scale 102 detects changes in weight and transmits corresponding signals to the processor 103. The processor 103 may compare measured weight to a target value and adjust operation of the liquid dispensing assembly 201 and particulate dispensing assembly 301 accordingly. In certain embodiments, the processor 103 may terminate or adjust dispensing when the detected weight reaches or approaches a predetermined target weight.

The processor 103 may be integrated within the user interface 104 or may be separately disposed within the housing body 101. In embodiments where separately disposed, the processor 103 is mounted to an internal control board and electrically coupled to the user interface 104. Communication between the processor 103 and user interface 104 may occur via wired electrical connections or wireless communication protocols. The processor 103 may further include wireless communication capability enabling transmission of operational data, dispensing parameters, and diagnostic information to external devices. The processor 103 may include one or more microcontrollers, microprocessors, embedded computing modules, memory components, and associated circuitry configured to execute programmed control instructions.

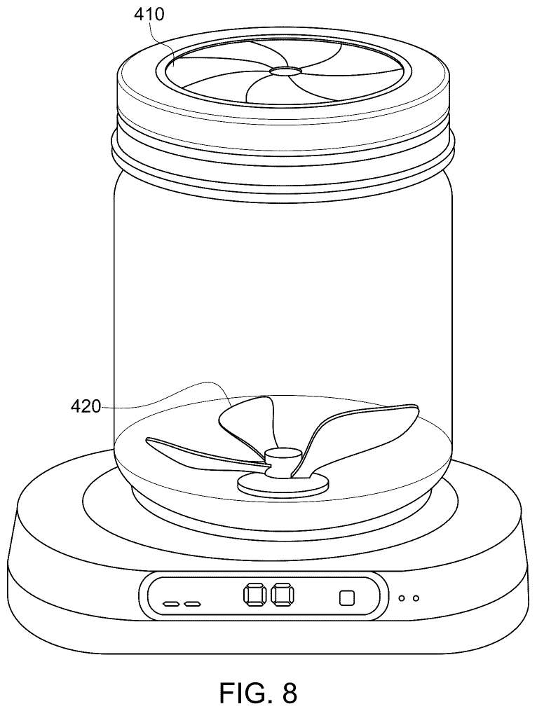

FIG. 8 illustrates an embodiment of a base-driven magnetic agitation system integrated with the fermentation maintenance machine 100. In this embodiment, an agitation motor is disposed beneath the fermentation vessel 400, such as beneath or within the scale 102. The agitation motor is communicatively coupled to the processor 103 and configured to receive control signals corresponding to activation timing, rotational speed, rotational direction, and agitation duration.

The agitation motor drives a magnetic drive element positioned below a bottom wall of the fermentation vessel 400. A corresponding driven magnetic element is coupled to an internal impeller disposed within the fermentation vessel 400. Rotation of the magnetic drive element causes corresponding rotation of the internal impeller through magnetic coupling without requiring a drive shaft to penetrate the lid 410.

The processor 103 is configured to coordinate operation of the agitation system with dispensing operations, lid actuation, and weight monitoring from the scale 102. In certain embodiments, the processor 103 executes programmed agitation sequences before, during, or after ingredient dispensing, including pulsed agitation cycles, alternating rotational directions, and variable-speed mixing profiles.

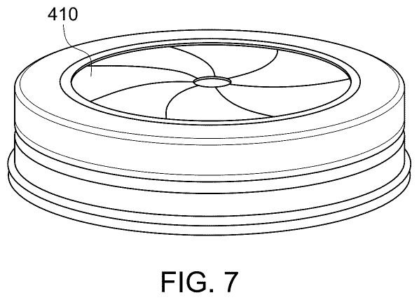

FIG. 7 illustrates an automated iris-style lid mechanism configured for controlled opening and closing of a central dispensing aperture. The iris mechanism includes a plurality of overlapping blades movable between a closed position and an open position. Movement of the iris blades is driven by an actuator communicatively coupled to the processor 103.

The actuator may include a motor, gear assembly, cam mechanism, linkage system, or equivalent movement device configured to translate processor-generated control signals into blade movement. The processor 103 is configured to generate control signals to move the iris mechanism between positions in response to user input, scheduled feeding events, or automated dispensing sequences.

In certain embodiments, the processor 103 coordinates iris actuation with operation of the liquid dispensing assembly 201, particulate dispensing assembly 301, and agitation system, such that the iris opens prior to dispensing and closes after dispensing terminates. The processor 103 may further confirm iris position using a position sensor, limit switch, encoder, optical sensor, or time-based actuation logic.

In certain embodiments, the iris-type lid assembly includes a plurality of overlapping blades arranged circumferentially around the opening of the fermentation vessel. Each blade may be pivotably mounted to a lid housing and include a guide slot. A rotatable actuation ring may include drive pins extending into the guide slots of the blades. Rotation of the actuation ring causes coordinated sliding movement of the blades relative to one another to vary the size of an aperture defined by the blades. The actuation ring may be driven by an electric motor, servo motor, stepper motor, or manual actuator under control of the processor. In certain embodiments, the actuator is mechanically coupled to the rotatable actuation ring such that actuation of the actuator causes rotational movement of the actuation ring to drive coordinated movement of the blades.

### Control Logic, Calibration, and Proximity-Based Dispensing Control

In certain embodiments, the processor 103 includes or is communicatively coupled to a memory configured to store calibration data, operational parameters, and target dispensing values. The memory may include non-volatile memory, volatile memory, or equivalent data storage structures capable of storing calibration coefficients and control instructions.

In some embodiments, the processor 103 is configured to determine a volume of liquid or dry particulate ingredient based on weight feedback received from the scale 102 and one or more stored weight-to-volume calibration values. The weight-to-volume calibration value may correspond to a known density of the liquid or dry particulate ingredient. The calibration value may be pre-programmed, selected by a user through the user interface 104, or generated through a calibration routine.

For particulate dispensing, the processor 103 may store a rotation-to-quantity calibration value corresponding to an estimated quantity of particulate material displaced per unit of rotational movement of the rotatable displacement member 304. The rotation sensor may generate signals corresponding to rotational speed, angular displacement, pulse count, or equivalent motion parameters. The processor 103 may estimate a dispensed quantity based on accumulated rotation data and the stored calibration value.

In certain embodiments, dispensing control is performed using a multi-stage control strategy. During an initial dispensing stage, the processor 103 may operate the liquid dispensing assembly 201 or particulate dispensing assembly 301 at an initial dispensing rate. The initial dispensing rate may correspond to a predefined pump speed, motor speed, or duty cycle.

The processor 103 may define a predefined proximity band corresponding to a percentage range of a selected target quantity. In certain embodiments, the predefined proximity band corresponds to a range between approximately 85% and 95% of the selected target quantity. When a measured or estimated dispensed quantity enters the predefined proximity band, the processor 103 reduces the dispensing rate.

For liquid dispensing, the processor 103 may reduce the dispensing rate by decreasing the operating speed of the peristaltic pump 202. In certain embodiments, the reduced flow rate corresponds to between approximately 10% and 50% of the initial flow rate.

For particulate dispensing, the processor 103 may reduce the dispensing rate by decreasing the rotational speed of the motor 305 driving the rotatable displacement member 304. In certain embodiments, the reduced dispensing rate corresponds to between approximately 10% and 50% of the initial dispensing rate.

Reduction of the dispensing rate may be initiated upon detection by a first one of the flow meter 203, the rotation sensor, or the scale 102 indicating that the dispensed quantity has entered the predefined proximity band. Thereafter, final dispensing may be regulated primarily based on real-time weight feedback from the scale 102 to improve precision.

The processor 103 may continuously compare real-time weight measurements to a selected target weight value. When the detected weight reaches or exceeds the selected target quantity within a defined tolerance range, the processor 103 terminates operation of the corresponding dispensing assembly.

In certain embodiments, the fermentation vessel 400 includes a lid 410 configured to move between a closed position and an open position. The lid 410 may be manually actuated by a user or automatically actuated by an actuator operatively coupled to the processor 103. The actuator may include a motor, linear actuator, or equivalent movement mechanism.

The processor 103 may be configured to generate a control signal to open the lid 410 prior to initiating dispensing of liquid or particulate material. After dispensing is terminated, the processor 103 may generate a control signal to close the lid 410.

In certain embodiments, the lid 410 of the fermentation vessel 400 includes an automated retractable aperture mechanism. In some embodiments, the retractable aperture includes an iris-style mechanism comprising a plurality of overlapping blades arranged circumferentially about a central opening. The blades are movable between a closed position, in which the blades overlap to substantially seal a central aperture, and an open position, in which the blades retract radially to define a central dispensing opening.

In certain embodiments, the iris mechanism is integrated within a lid body configured to maintain an overall outer diameter and profile corresponding approximately to that of a standard wide-mouth mason jar lid. When the iris is in the closed position, the lid remains low-profile and maintains a substantially continuous upper surface to preserve sealing performance during fermentation.

The iris blades may be fabricated from stainless steel, polymer, coated metal, or other food-safe materials. The blades may slide along arcuate guide tracks formed within the lid body. Movement of the blades may be coordinated through a ring gear, cam ring, or linkage assembly configured to simultaneously retract or advance the blades.

In certain embodiments, actuation of the iris mechanism is mechanical. In other embodiments, the iris mechanism is motor-driven. A lid actuator motor may be disposed within the lid housing or externally coupled to the lid. The motor may drive a cam ring or gear mechanism configured to rotate relative to the lid body, thereby moving the iris blades between the closed and open positions.

The lid actuator motor is electrically or communicably coupled to the processor 103 and may be powered by the power supply of the fermentation maintenance machine 100. The processor 103 may generate a control signal to actuate the iris mechanism according to a scheduled dispensing sequence. In certain embodiments, the processor 103 confirms the open or closed state of the iris mechanism using a position sensor, limit switch, optical sensor, encoder, or time-based actuation control.

In scheduled or autonomous modes, the processor 103 may execute a sequence comprising maintaining the lid in a closed state during fermentation, generating a signal to retract the iris blades at a scheduled feeding time to create a central dispensing opening, initiating dispensing of liquid and/or particulate material through the central opening, and generating a signal to return the iris blades to the closed position after dispensing terminates.

In certain embodiments, the lid further includes a manually actuated control, such as a button or touch-sensitive region, configured to allow a user to manually open or close the iris mechanism independent of automated scheduling. Manual actuation may be processed by the processor 103 or may directly control the lid actuator.

The iris mechanism may include sealing elements such as gaskets, overlapping blade geometries, or compression seals configured to reduce air ingress, moisture loss, or contamination when in the closed position.

The fermentation vessel 400 may further include an agitator 420 disposed within the vessel. The agitator 420 may include a motor-driven shaft with one or more mixing elements configured to agitate contents within the vessel. The agitator 420 may be manually activated or controlled by the processor 103.

In certain embodiments, the processor 103 is configured to activate the agitator 420 after the lid 410 is closed and to maintain agitation for a predetermined agitation period. The predetermined agitation period may be stored in memory and may be user-selectable through the user interface 104. After expiration of the predetermined agitation period, the processor 103 terminates operation of the agitator 420.

### Base-Driven Automated Agitation

In certain embodiments, the fermentation vessel 400 includes an automated agitation system configured to mix viscous starter material without requiring a drive shaft extending through the lid 410.

In at least one embodiment, agitation is provided through a base-driven magnetic coupling system. A drive motor may be disposed beneath, directly above, or integrated within the scale 102. The drive motor may rotate a magnetic drive element positioned below the base of the fermentation vessel 400. A corresponding driven magnetic element is coupled to an agitator such as an impeller or paddle disposed within the fermentation vessel 400.

The internal impeller may be low-profile and configured to promote bottom-up turnover of viscous starter material. In certain embodiments, the impeller includes folding blades configured to lift material from the bottom surface and redistribute it toward upper regions of the vessel. The impeller may further include side-scraping edges or curved surfaces configured to lightly contact interior vessel walls to promote incorporation of newly dispensed flour and water.

The magnetic coupling allows rotational torque transfer through the base of the fermentation vessel without penetrating the lid, thereby preserving a sealed, low-profile lid structure. The impeller may be removable for cleaning.

The processor 103 is configured to control operation of the drive motor. In certain embodiments, the processor 103 activates the drive motor prior to dispensing to initiate agitation within the fermentation vessel. The processor 103 may maintain agitation for a predetermined duration and subsequently terminate agitation by discontinuing activation of the drive motor. After termination of agitation, the processor 103 may generate a control signal to open the iris lid and initiate dispensing of liquid and/or particulate ingredients into the fermentation vessel. Following termination of dispensing, the processor 103 generates a control signal to close the iris lid and may then reactivate the drive motor to agitate the newly dispensed ingredients within the vessel. In some embodiments, the predetermined agitation duration may be selected by a user. In certain embodiments, when dispensing a dry particulate ingredient, the processor 103 generates a control signal to actuate the shutter door assembly 350 to move the shutter door flap 353 to an open position within the duct 398 prior to dispensing. After termination of particulate dispensing, the processor 103 generates a control signal to return the shutter door flap 353 to a closed position.

The processor 103 may further control agitation using pulsed mixing cycles, alternating rotational directions, variable speeds, or time-based patterns configured to prevent channeling and promote uniform incorporation. Alternating rotation direction may be used to prevent formation of preferential flow paths within viscous starter material.

The processor 103 may control rotational speed, oscillation amplitude, orbital frequency, and duration to achieve desired mixing performance. Pulsed and alternating motion patterns may be used to promote thorough incorporation while minimizing shear.

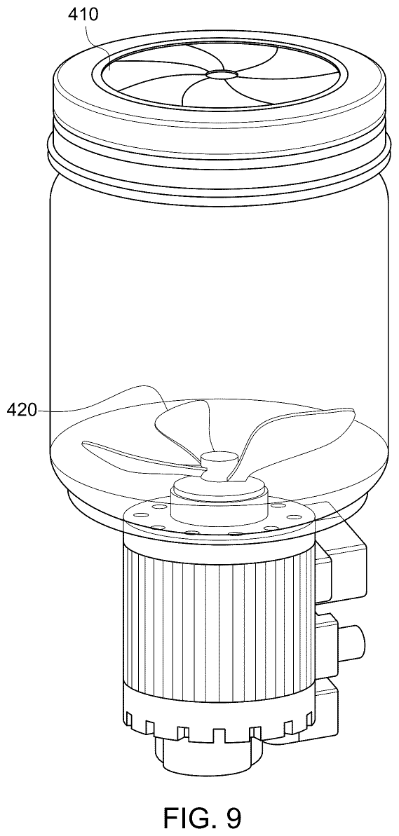

In certain embodiments, as shown in FIG. 9, agitation is achieved through a mechanically driven base-coupling system integrated with the scale assembly 102. A motor assembly may be positioned above, within or beneath the scale platform such that the motor forms part of the integrated scale structure.

The motor includes a motor shaft that rotates when the motor is activated. A motor drive coupler is mounted to the motor shaft and rotates with the motor shaft. The motor drive coupler may extend upward through an opening or drive port in the scale platform so that the coupling interface is accessible at the surface upon which the fermentation vessel 400 rests.

The fermentation vessel 400 may include a corresponding driven coupler formed in or attached to the base of the vessel. In certain embodiments, the bottom wall of the vessel defines a recessed drive socket configured to receive and engage the motor drive coupler when the vessel is placed on the scale platform. The driven coupler may include a keyed socket, splined receiver, hexagonal receiver, bayonet interface, or other rotational engagement structure capable of transmitting torque.

When the fermentation vessel 400 is positioned on the scale platform, the motor drive coupler engages the driven coupler of the vessel. The driven coupler is connected to a drive shaft extending upward into the vessel interior. The drive shaft is mechanically connected to an internal agitator such as an impeller disposed within the fermentation vessel 400. Accordingly, rotation of the motor shaft rotates the motor drive coupler, which engages the driven coupler and rotates the drive shaft, thereby rotating the impeller within the vessel.

In certain embodiments, the drive shaft extends through the bottom wall of the vessel through a sealed bearing assembly integrated into the vessel base. The bearing assembly may include a food-safe rotary seal configured to prevent leakage of starter material while permitting rotational motion of the shaft.

The internal impeller may include blender-type blades, folding paddles, or curved lifting surfaces configured to promote bottom-up turnover of viscous starter material. In certain embodiments, the impeller includes upwardly angled blades configured to lift material from a bottom central region and redistribute the material toward upper regions of the vessel.

The motor assembly may be mounted beneath the load cell structure of the scale 102, allowing the scale to continue measuring the weight of the vessel during agitation. The scale 102 is communicatively coupled to the processor 103 and configured to transmit real-time weight data during operation of the motor.

The motor is also communicatively coupled to the processor 103. The processor 103 may control rotational speed of the motor, initiate and terminate agitation cycles, alternate rotational direction, or implement pulsed mixing patterns while simultaneously receiving weight data from the scale.

In certain embodiments, the processor 103 may compensate for transient load fluctuations caused by agitation by applying digital filtering to the measured weight data. Ingredient dispensing may be temporarily suspended during high-speed agitation and resumed during reduced-speed or paused intervals to maintain accurate gravimetric measurements.

In certain embodiments, the drive coupling between the motor and the vessel is removably engaged, such that lifting the vessel from the scale platform automatically disengages the couplers. Alignment features, including tapered coupling surfaces or magnetic alignment elements, may assist in proper engagement when the vessel is placed on the scale platform.

In certain embodiments, the mechanical coupling between the fermentation vessel 400 and the motor-driven drive member is configured to transmit rotational torque without supporting the weight of the vessel. The fermentation vessel 400 may rest directly on the scale platform of the scale assembly 102, such that the full weight of the vessel and its contents is supported by the scale and measured by the load cells. The motor drive coupler and corresponding driven coupler may be configured to engage with rotational clearance in the vertical direction, such that the coupling transmits rotational motion while substantially no vertical load from the vessel is borne by the motor shaft or motor drive coupler. In certain embodiments, the coupling interface may include vertical clearance, floating engagement surfaces, or torque-transmitting features that permit rotational engagement while isolating the motor assembly from compressive load forces. Accordingly, the scale assembly 102 may remain responsible for supporting and measuring the weight of the vessel during agitation while the motor assembly functions solely to provide rotational drive to the impeller.

### Agitation and Lid Sequence Control

In certain embodiments, the processor 103 executes a coordinated sequence comprising: activating agitation while the lid 410 remains closed to homogenize existing starter material; terminating agitation; generating a signal to open the iris aperture; dispensing liquid and/or particulate material through the aperture; generating a signal to close the iris aperture; and reactivating agitation to incorporate newly dispensed ingredients.

The sequence may be executed in response to a scheduled feeding event, user input, environmental condition, or autonomous maintenance mode. The sequence parameters, including agitation duration, speed, and direction, may be stored in memory and adjusted via the user interface 104.

### Method Operation Support

During operation, the fermentation vessel 400 is supported on the scale 102. The processor 103 receives a target quantity input from the user interface 104 corresponding to a desired quantity of liquid or dry particulate ingredient to be dispensed into the fermentation vessel 400. The processor 103 initiates dispensing via the liquid dispensing assembly 201 or particulate dispensing assembly 301 and monitors weight feedback from the scale 102 during dispensing. Where applicable, the processor 103 also monitors flow rate data from the flow meter 203 and/or rotation data from the rotation sensor. When a measured or estimated dispensed quantity enters the predefined proximity band, the processor 103 reduces the dispensing rate. Dispensing continues at the reduced rate until the scale 102 indicates that the target quantity has been reached, at which point dispensing is terminated.

In certain embodiments, the fermentation maintenance machine 100 may operate in a scheduled or autonomous feeding mode. In such embodiments, the processor 103 is configured to initiate dispensing of liquid and/or dry particulate ingredients at predetermined time intervals without requiring manual initiation by a user. The processor 103 may include or be communicatively coupled to a memory storing scheduling data, including feeding times, interval durations, cycle frequency, and ingredient quantities. A user may input scheduling parameters via the user interface 104, or scheduling data may be pre-programmed or received from an external device through wired or wireless communication. In some embodiments, the processor 103 maintains an internal clock or timer configured to track elapsed time. When a scheduled feeding time is reached, the processor 103 automatically initiates operation of the liquid dispensing assembly 201 and/or particulate dispensing assembly 301 in accordance with stored parameters. The scheduled or autonomous feeding mode may include single-cycle operation or recurring operation over extended time periods, including hours, days, or weeks.

In certain embodiments, the processor 103 is configured to execute a multi-cycle maintenance mode. In such mode, the processor 103 may initiate dispensing at multiple predetermined intervals, vary ingredient quantities between cycles, alternate between liquid and particulate dispensing, and initiate agitation cycles between dispensing events. The maintenance mode may include a repeating schedule stored in memory and executed until manually terminated by a user or until a programmed completion condition is met. In some embodiments, the processor 103 monitors cumulative weight data from the scale 102 to determine historical feeding quantities and adjust subsequent cycles accordingly. The processor 103 may also store historical dispensing data and use such data to regulate future cycles.

In certain embodiments, the fermentation maintenance machine 100 further includes one or more environmental sensors disposed within or proximate to the fermentation vessel 400 or housing body 101. The environmental sensor may include a temperature sensor, humidity sensor, gas sensor, pressure sensor, or equivalent environmental sensing device. The environmental sensor is communicatively coupled to the processor 103 and provides environmental feedback. In certain embodiments, the processor 103 is configured to modify dispensing intervals, ingredient quantities, or agitation periods based on environmental feedback. For example, if a detected temperature exceeds a predetermined threshold, the processor 103 may reduce feeding intervals. If detected temperature falls below a threshold, the processor 103 may increase feeding intervals. If fermentation activity is inferred from environmental data, the processor 103 may adjust agitation timing. Environmental threshold values may be stored in memory and may be user-adjustable via the user interface 104.

In some embodiments, the processor 103 executes adaptive control logic wherein feeding intervals are dynamically adjusted based on a combination of elapsed time, environmental sensor data, cumulative dispensing data, and user-defined parameters. The processor 103 may determine that a feeding cycle should be initiated when one or more triggering conditions are met, including time-based triggers, environmental thresholds, or weight-based conditions.

In certain embodiments, scheduling parameters and maintenance modes may be transmitted to the processor 103 from an external device via wireless communication. The processor 103 may receive updated schedules, feeding quantities, or environmental threshold parameters and execute dispensing operations accordingly. The processor 103 may further transmit operational status, environmental readings, and dispensing history to an external device.

In certain embodiments, the processor 103 is configured to execute a coordinated dispensing and agitation sequence. Upon initiation of a feeding cycle, whether in response to user input or a scheduled maintenance event, the processor 103 generates a control signal to activate an agitation device disposed within the fermentation vessel 400 while the lid 410 remains in a closed position. The agitation may be performed for a predetermined duration to homogenize existing contents within the vessel.

After the initial agitation period, the processor 103 terminates agitation and generates a control signal to open the lid 410. In embodiments including an iris-style retractable aperture, the processor 103 actuates the lid mechanism to move from a closed position to an open dispensing position. If dispensing of dry particulate material is to occur, the processor 103 may also generate a control signal to actuate the shutter door assembly 350 to move the shutter door flap 353 to an open position within the duct 398.

The processor 103 then initiates dispensing by generating a control signal to either (i) activate the peristaltic pump 202 of the liquid dispensing assembly 201 or (ii) activate the motor 305 driving the rotatable displacement member 304 of the particulate dispensing assembly 301. During liquid dispensing, the processor 103 monitors liquid flow data received from the flow meter 203. During particulate dispensing, the processor 103 monitors rotation data received from the rotation sensor and estimates dispensed quantity based on accumulated rotational movement and a stored rotation-to-quantity calibration value.

Throughout dispensing, the processor 103 continuously monitors weight feedback from the scale 102 supporting the fermentation vessel 400. When the measured or estimated dispensed quantity approaches a selected target quantity, including entry into a predefined proximity band, the processor 103 reduces the operating speed of the peristaltic pump 202 or the motor 305 to slow the dispensing rate. Final dispensing is regulated primarily based on real-time weight feedback from the scale 102 to achieve improved precision.

When the processor 103 determines that the measured weight corresponds to the selected target quantity within a defined tolerance range, the processor 103 generates a control signal to terminate operation of the peristaltic pump 202 or the motor 305. If particulate dispensing has occurred, the processor 103 further generates a control signal to close the shutter door flap 353 within the duct 398 to prevent unintended discharge.

After dispensing is terminated, the processor 103 generates a control signal to close the lid 410 to reseal the fermentation vessel 400. The processor 103 may then reinitiate agitation within the fermentation vessel 400 for a predetermined duration to incorporate newly dispensed liquid and/or particulate material, thereby promoting thorough bottom-up folding and mixing of viscous starter contents.

In certain embodiments, entry into the predefined proximity band may be detected based on feedback from a first one of the flow meter 203, the rotation sensor, or the scale 102, and the processor 103 may initiate reduction of the dispensing rate in response to such detection.

In certain embodiments, the fermentation maintenance machine 100 is configured to operate continuously over extended periods while periodically initiating maintenance cycles. The processor 103 may manage power consumption by placing selected components into a reduced power state between cycles and activating components only when required for dispensing, sensing, agitation, or communication.

In certain embodiments, the system includes a power supply configured to provide electrical power to the processor, sensors, dispensing assemblies, motors, and communication modules. The power supply may include an AC power connection, an internal power supply unit, or a rechargeable battery system. Electrical power may be distributed to system components through conductive wiring, printed circuit board traces, or other electrical interconnect structures.

The processor may be communicatively coupled to system components including motors, pumps, sensors, and dispensing assemblies through wired or wireless communication interfaces. In some embodiments, communication may occur through electrical control signals transmitted through control circuitry, motor drivers, or communication buses. In other embodiments, communication may occur through wireless interfaces including Wi-Fi, Bluetooth, or other short-range communication protocols.

As used herein, the terms “comprising,” “including,” and “having” are open-ended and do not exclude the presence of additional elements, steps, or features not expressly recited. The structures and methods described herein may be implemented in one or more embodiments, and various modifications, substitutions, and combinations may be made without departing from the scope of the appended claims. Terms such as “top,” “bottom,” “upper,” “lower,” “front,” “rear,” “left,” “right,” “anterior,” “posterior,” “medial,” and “lateral” are used for descriptive purposes only and are not intended to be limiting unless expressly stated. The drawings are provided for illustrative purposes only and are not intended to limit the scope of the disclosure or the appended claims.

What is claimed is:

1. A fermentation maintenance machine comprising:
a liquid container configured to dispense a liquid;
a particulate container configured to dispense a dry particulate ingredient;
a housing body, wherein the liquid container and the particulate container are coupled to the housing body;
the housing body including a liquid dispensing assembly and a particulate dispensing assembly configured to selectively dispense the liquid and the dry particulate ingredient into a fermentation vessel;
wherein the fermentation vessel is supported on a scale;
a processor communicatively coupled to the scale, the liquid dispensing assembly, and the particulate dispensing assembly;
a user interface communicatively coupled to the processor; and
wherein the processor is configured to control operation of the liquid dispensing assembly and the particulate dispensing assembly based on feedback received from the scale.

2. The fermentation maintenance machine of claim 1, wherein the processor is configured to receive a user input corresponding to a target quantity of at least one of the liquid or the dry particulate ingredient to be dispensed, and wherein the processor is configured to control the liquid dispensing assembly or the particulate dispensing assembly to dispense the selected ingredient until feedback received from the scale indicates that the target quantity has been reached, at which point the processor terminates dispensing.

3. The fermentation maintenance machine of claim 2, wherein the fermentation vessel includes a lid configured to move between a closed position and an open position, and wherein the lid is configured to open either in response to manual activation by a user or automatically in response to a control signal generated by the processor.

4. The fermentation maintenance machine of claim 2, wherein the fermentation vessel includes an agitator disposed within the fermentation vessel, and the processor is configured to selectively activate the agitator.

5. The fermentation maintenance machine of claim 2, wherein the processor is configured to determine a volume of the liquid or the dry particulate ingredient to be dispensed based on weight feedback received from the scale and a stored weight-to-volume calibration value corresponding to the liquid or the dry particulate ingredient.

6. The fermentation maintenance machine of claim 2, wherein the fermentation vessel includes a lid and an agitator, and wherein the processor is configured to open the lid prior to initiating dispensing of the liquid or the dry particulate ingredient, close the lid after termination of dispensing, activate the agitator after the lid is closed, and terminate operation of the agitator after a predetermined agitation period.

7. The fermentation maintenance machine of claim 1, further comprising a flow meter operatively coupled to the liquid dispensing assembly, wherein the processor is configured to control dispensing of the liquid based on feedback from the flow meter and the scale, and wherein the processor is further configured to reduce a flow rate of the liquid dispensing assembly when a measured dispensed quantity is within a predefined proximity band of a selected target quantity, such that the remaining dispensing is regulated based on weight feedback received from the scale to improve dispensing precision.

8. The fermentation maintenance machine of claim 1, wherein the particulate dispensing assembly includes a rotatable dispensing member and a rotation sensor operatively coupled to the rotatable dispensing member, wherein the processor is configured to estimate a dispensed quantity of the dry particulate ingredient based on rotation feedback received from the rotation sensor and a stored rotation-to-quantity calibration value, wherein the processor is configured to control dispensing based on feedback from the estimated dispensed quantity and weight feedback received from the scale, and wherein the processor is further configured to reduce a dispensing rate of the particulate dispensing assembly when the estimated dispensed quantity is within a predefined proximity band of a selected target quantity, such that the remaining dispensing is regulated based on weight feedback received from the scale to improve dispensing precision.

9. The fermentation maintenance machine of claim 7, wherein the predefined proximity band corresponds to a range between 85% and 95% of the selected target quantity.

10. The fermentation maintenance machine of claim 7, wherein the reduced flow rate corresponds to between 10% and 50% of an initial flow rate of the liquid dispensing assembly prior to entering the predefined proximity band.

11. The fermentation maintenance machine of claim 8, wherein the predefined proximity band corresponds to a range between 85% and 95% of the selected target quantity.

12. The fermentation maintenance machine of claim 8, wherein the reduced dispensing rate corresponds to between 10% and 50% of an initial dispensing rate of the particulate dispensing assembly prior to entering the predefined proximity band.

13. The fermentation maintenance machine of claim 7, wherein the processor is configured to initiate reduction of the flow rate of the liquid dispensing assembly upon detection by a first one of the flow meter or the scale to indicate that the measured dispensed quantity has entered the predefined proximity band of the selected target quantity.

14. The fermentation maintenance machine of claim 8, wherein the processor is configured to initiate reduction of the dispensing rate of the particulate dispensing assembly upon detection by a first one of the rotation sensor or the scale to indicate that the estimated dispensed quantity has entered the predefined proximity band of the selected target quantity.

15. The fermentation maintenance machine of claim 1, wherein the fermentation vessel includes an impeller disposed within the fermentation vessel, and wherein the processor is communicatively coupled to a motor operatively coupled to the impeller, the processor being configured to control operation of the motor to rotate the impeller to agitate contents within the fermentation vessel.

16. The fermentation maintenance machine of claim 15, wherein the motor is mechanically coupled to the impeller through a drive shaft extending through a lower portion of the fermentation vessel, the drive shaft being configured to transmit rotational torque from the motor to the impeller while permitting the fermentation vessel to remain supported by the scale.

17. The fermentation maintenance machine of claim 15, wherein the motor is magnetically coupled to the impeller through a magnetic drive assembly, the magnetic drive assembly including a first magnet coupled to a motor-driven rotor and a second magnet coupled to the impeller, such that rotation of the motor causes rotation of the impeller without direct mechanical contact between the motor and the impeller.

18. The fermentation maintenance machine of claim 1, further comprising an iris-type lid assembly disposed at an upper opening of the fermentation vessel, the iris-type lid assembly including a plurality of overlapping movable segments configured to move between (i) a closed position covering the opening of the fermentation vessel and (ii) an open position defining an aperture through which ingredients may be dispensed into the fermentation vessel.

19. The fermentation maintenance machine of claim 18, wherein the iris-type lid assembly includes a rotatable actuation ring, a plurality of overlapping blades pivotably mounted to a lid housing, and a plurality of guide pins extending from the actuation ring into slots formed in the blades such that rotation of the actuation ring causes coordinated sliding movement of the blades to vary an aperture size.

20. The fermentation maintenance machine of claim 1, wherein the processor is configured to control operation of the fermentation maintenance machine according to a sequence comprising:
(i) activating a motor operatively associated with the scale, the motor being operatively coupled to an impeller disposed within the fermentation vessel such that activation of the motor rotates the impeller to agitate contents within the fermentation vessel;
(ii) opening an iris-type lid disposed at an upper opening of the fermentation vessel;
(iii) opening a particulate dispensing flap when the processor initiates dispensing of particulate material;
(iv) dispensing liquid into the fermentation vessel using a pump of the liquid dispensing assembly or dispensing particulate material using the particulate dispensing assembly;
(v) terminating dispensing of the liquid or particulate material;
(vi) closing the particulate dispensing flap when particulate dispensing is terminated;
(vii) closing the iris-type lid; and
(viii) activating the motor to rotate the impeller to agitate contents within the fermentation vessel following closure of the iris-type lid.
